(19) United States
(12) Patent Application Publication
(10) Pub. No.: US 2007/0297071 A1
(43) Pub. Date: Dec. 27, 2007

(54) Optical Imaging Device for a Camera

(75) Inventor: Frank J. Wurster, Stuttgart (DE)

Correspondence Address: AKERMAN SENTERFITT, P.O. BOX 3188, WEST PALM BEACH, FL, 33402-3188, US

(73) Assignees: FRANK J. WURSTER, STUTTGART (DE); ANGELA JEDEK, STUTTGART (DE); JÜRGEN KILLENBERGER, STUTTGART (DE)

(21) Appl. No.: 10/598,414

(22) PCT Filed: Mar. 3, 2004
(86) PCT No.: PCT/EP05/02149

§ 371 Date: Mar. 14, 2007

(30) Foreign Application Priority Data
Mar. 3, 2004 (DE) 10 2004 010971.0

(51) Int. Cl. G02B 13/20

(52) U.S. Cl. 359/707

(57) ABSTRACT

The invention relates to an optical device for a photographic camera (2), such as a camera, cine-camera or a video camera. The imaging device is arranged in an optical path (3) between a lens (4) at the beginning of the optical path (3) and an image receiving device (5) of the camera (2) at the end of the optical path (3). The inventive device comprises an imaging lens (6) which is provided with a transparent, light-diffusing imaging surface (7) which is used make visible a real image of the lens (4), and a transmission lens (8) comprising a transmission lens (9) which is used to reproduce the real image from the lens (4) on to the image capturing device (5). An imaging lens arrangement (10) is provided as an imaging lens (6), which contains a diffusion layer (14) made of a light-diffusing substance, and a lens which is superimposed on the diffusion layer with the surface (15) which is curved in an outward manner. The imaging lens arrangement (10) has a semi-value angle (β) smaller or equal to 30° and greater than 10°.

The invention relates to an optical device for a photographic camera, such as a camera, cine camera or video camera of the type defined in the preamble of claim 1.

When viewing an image the observer can easily distinguish between images from a cine recording and those from a video camera, the optical impression of the cine recordings generally being considered more pleasing. It is known that, apart from a lower resolution of the video image and an unsatisfactory contrast behaviour compared with the cine image, this effect is largely due to the considerable depth of field of the video image. On recording objects at a specific distance from the focal plane, in the case of a specific focal length and aperture, there is a fixed depth of field, which is initially independent of the circle of least confusion of the given recording format. It is generally the case that with increasing format size the depth of field decreases. Thus, compared with the ⅓ inch video format, the larger 35 mm cine format has a depth of field lower by a factor of roughly 5 for the same diaphragm step and viewing angle.

In the case of digital image recording by a video camera, the image is recorded on an image recording device in the form of a photosensitive chip, which is small compared with the gate of a cine camera, with a film as the image recording device with a 35 mm recording format, so that the recorded video image has a much higher depth of field than the comparable cine image. This characteristic can easily be perceived by the image viewer. The considerable depth of field of a video camera is undesirable for demanding recording or photographing purposes. Instead a limited depth of field is used as a design element, which is only possible to a very restricted extent with small recording formats.

In order in the case of the same viewing angle and aperture as in 35 mm cine cameras, video cameras and cameras having a random recording format, to obtain the same ratios of the depth of field, it is known to place an optical adapter in front of the camera. Such an optical adapter is described in the journal article “Keine kleine 35er, aber . . . ”, Film & TV Kameramann December 2001 of 20.12.2001, pp 18 to 20. The known optical adapter comprises a lens and a focussing screen as the projection optics and the real image is made visible on its transparent projection area. This intermediate image is made available for recording in an image output at the end of the optical path in the known adapter. Thus, the digital camera films the intermediate image and in the small size digital camera there are the same focal length and depth of field ratios as in the large 35 mm cine camera.

The focussing screen of the known adapter is rotated by an electric motor, so that the stationary grain of the focussing screen is invisible, e.g. during camera panning. As a result of the rapid rotary movement it is no longer possible to locate the granularity, but it is not eliminated. On the recorded image is deposited a diffuser film having the size of the grain and this is undesired, particularly for against the light shots. The known focussing screen must also have a specific thickness and grain size in order to prevent a through-focussing of the image by the focussing screen. Through-focussing occurs if the focussing screen is too thin. The light collected in the focus of the upstream lens has inadequate light-refracting elements on the focussing screen, so that there is at least a partial aerial image. The focussing screen behaves in a similar manner to a clear glass disk which, when looked through, reveals the aperture. To avoid undesired through-focussing the focussing disk must be sufficiently opaque and as a result the arrangement is of a low power nature.

The imaging of a so-called hot spot must also be avoided. The hot spot effect arises if the focussing screen does not have an adequate diffusing action. The small beam bounded by the iris of the upstream lens is then diffused in an unhomogeneous surface manner, so that the image centre as the hot spot is brighter than the image edges. To avoid the hot spot the focussing screen has an adequately large half-power angle which, however, like a high opacity, undesirably reduces the light intensity.

On reproducing photographic recordings with the known adapter the operating noise of the drive motor for the rotating focussing screen is disturbingly audible. Moreover, particularly in the case of a photographic recording with a closed diaphragm, due to the greater depth of field, the granularity of the focussing screen as rotating dots are visible in the form of small black circles. Such photographic recordings of reduced quality are frequently unusable.

Back projection devices for projector screens are also known, where a layer of light-diffusing substance is placed between two plane-parallel foils or plates of transparent material. EP 27 287 B1 describes such a back projection screen for observing microfilms, in which as a result of the ratio of the observation distance to the size of the projected image, the image edges are observed under a greater viewing angle than the image centre and in this way the hot spot effect occurs. According to EP 27 287 B1, to avoid the problem of the bright image patch, between the plane-parallel plates of glass or some other transparent material is placed a wax mixture of a substance having a low light diffusing power such as paraffin and a wax with a high diffusing power such as beeswax. The known principle of an advantageously thick wax layer between plane-parallel plates is provided for a high power projector. The enormous light losses of the thick wax layer prevent a transfer of this known arrangement for high power projectors to photographic cameras.

The problem of the present invention is to so further develop an optical device for a photographic camera of the type specified in the preamble of claim 1 that with very limited structural measures an improvement to the recordable image quality is possible.

According to the invention this problem is solved by an optical device having the features of claim 1.

An optical device for a photographic camera with imaging optics is proposed, in which the imaging optics are constituted by an imaging lens arrangement, which contains a “light-diffusing layer” or “diffusing layer” formed by a light diffusing substance. A lens is provided and covers the diffusing layer with an outwardly curved surface, the focussing action of the lens increasing the light intensity of the real image to be filmed from the diffusing layer.

The invention takes account of the fact that an essential factor for the quality of the system is the angular spectrum with which the light beams leave the imaging lens arrangement. In the present application this angular spectrum is characterized by the so-called half-power angle. In the case of a planar diffusing layer the half-power angle is defined as the angle between the normal to the diffusing layer and the direction in which the light intensity of the diffused light at the light exit side of the imaging lens arrangement is equal to half the light intensity present at the light exit side in the normal direction to the diffusing layer if the imaging lens arrangement is uniformly illuminated in the normal direction from the light entry side. The half-power angle is inter alia codetermined by the optical material characteristics of the diffusing layer and its thickness. The thinner the diffusing layer and the lower the volume-specific diffusing power of the light-diffusing substance, the smaller the half-power angle and consequently the brighter the system. However, the half-power angle must not be chosen randomly small, because otherwise the hot spot effect occurs. In the hot spot the image centre is much brighter than the image edges and this can lead to an unusable image. However, excessive diffusion, i.e. a very large half-power angle, although favourable with respect to a uniform image brightness, can lead to light losses. On setting the half-power angle to values equal to or smaller than 30° and larger than 10° it is admittedly possible for a hot spot and also through-focussing to occur within limits. However, this is deliberately accepted and can at least largely be compensated by the remaining components of the proposed imaging device. The upper limit of the half-power angle is chosen in such a way that sufficient light intensity can be coupled into the following optics and a high power, precise image is obtained.

Thus, the invention permits a good compromise between opposing demands made on the imaging optics. On the one hand the light entering from the light entry side must be diffused in order to give a uniform, bright image and strong diffusion with large diffusing angles is advantageous for this. However, on the other hand the system must give rise to a minimum light loss, so that maximum light energy arises on the image recording device. Therefore diffusion losses are to be avoided or limited to an unavoidable minimum. The inventive compromise makes it possible to produce adequately uniformly illuminated, high power images.

The “diffusing layer” is formed by a layer of a light-diffusing substance. This makes it possible to create a diffusing element having diffusion centres not only in the vicinity of its surfaces, but also in the interior of the diffusing layer volume. Thus, even in the case of very small diffusing layer thicknesses advantageous for a high power image a strong diffusing power can be obtained. By combination with at least one lens block which, with an outwardly curved surface covers the diffusing layer in such a way that the optical action of a positive lens is obtained, the overall imaging lens arrangement can be so designed that its half-power angle is smaller than that of the isolated diffusing layer (without lens block). Thus, it is possible to use diffusing layers with a strong diffusing power without this leading to intolerable light losses.

Preferably the half-power angle of the imaging lens arrangement is less than 25°, particularly less than 22°.

In an advantageous development the combination of lens and diffusing layer is chosen in such a way that the half-power angle is between approximately 20° and approximately 15°. Particularly with a half-power angle below 20° a high light intensity is obtained in said angular range and hot spot and through-focussing effects can be compensated.

In preferred embodiments the imaging lens arrangement comprises two transparent support bodies, which with plane-parallel, horizontal surfaces define a gap into which the light-diffusing substance is introduced in such a way that the diffusing layer is received between the plane-parallel surfaces. Thus, the layer thickness is defined by the spacing of the plane-parallel surfaces perpendicular to the surface extension. It is possible in this case to use for the formation of the diffusing layer light-diffusing substances which, as a result of their material characteristics are unsuitable for forming a self-supporting layer. This also makes it possible to use very thin diffusing layers, which are stabilized by the transparent support bodies and protected against damage. In the case of adequate mechanical stability it is also possible to use self-supporting diffusing layers.

The lens block can be positioned with an appropriate, preferably small spacing from the diffusing layer. For example, it is possible to have a sandwich arrangement with two plane-parallel, transparent plates serving as support bodies and an interposed, enclosed diffusing layer, in the vicinity of which is positioned a separate lens block. Preferably at least one of the support bodies is constructed as a lens block, so that the diffusing layer engages directly on a planar surface of the lens block. The support body in the form of a lens then has a double function, namely as a support for the diffusing layer and as a light-focussing, optical element.

The construction of at least one support body as a lens with an outwardly curved surface also assists the homogeneous distribution of the beam, so that by combining the lens with the transparent layer a low layer thickness can be chosen. With a thin layer thickness a bright image is produced and consequently the light intensity of the entire imaging device is increased.

A transfer or transmission lens by means of which the real image of the upstream, large format lens imaged on the diffusing layer is imaged on the image recording device is appropriately constructed as a telephoto lens, particularly in the medium telephoto focal length range. The characteristic of a lens as a telephoto, normal or wide angle lens is dependent on the ratio of its focal length to the format of the image recording device. In the case of a video chip as the image recording device in a ⅔ inch format, a focal length of approximately 11 mm is looked upon as a normal lens. The advantageous, medium telephoto focal length range is between 20 and 65 mm inclusive. In other image recording device formats the appropriate focal length range can be correspondingly converted. The telephoto lens has a comparatively low depth of field, so that on the one hand the real image on the diffusing layer can be imaged precisely on the image recording device. On the other hand contaminants on the further optical elements behind the imaging optics are outside the sharpness range and do not or only slightly impair the image quality.

A preferred construction of the telephoto lens as a zoom lens with a variable focal length permits universal use of the imaging device in different cameras with different imaging formats.

The optical device is appropriately designed in such a way that the transmission lens in the case of infinite focussing sharply images the real image on the image recording device. There is no need for a complicated, aberrational refocussing of the transmission lens. In conjunction with an upstream field lens for obtaining the infinite focussing, a compact construction is obtained.

As a result of the described arrangement of the transmission lens it is possible to make the imaging lens arrangement so thin, opaque and therefore high power that in normal circumstances through-focussing would occur, but as a result of the selected focal length and assisted by the infinite focussing it is compensated and essentially no longer arises.

In an advantageous development between the upstream lens and the imaging lens arrangement is positioned a replaceable filter support, more particularly using a bayonet or screw joint. The filter support can e.g. contain a contrast filter by means of which the contrast behaviour of the image can be improved without any significant light loss. Due to the replaceable construction there is an open, non-encapsulated system, which with a limited construction volume and weight permits easy access to the imaging lens arrangement for cleaning and maintenance purposes.

The imaging lens arrangement is appropriately constructed in such a way that the entry-side support body is constructed as a transparent, plane-parallel plate and the exit-side support body as a planoconvex lens. The plane-parallel plate does not modify the imaging behaviour of the upstream lens. Use can be made of a large format, standardized cine camera lens without any adaptation work. With regards the focal length and depth of field the desired imaging characteristics are maintained. The exit-side, planoconvex lens focusses the diffused light of the diffusing layer and passes it with a high light yield in the direction of the transmission lens. There is a large format, real intermediate image of considerable brightness on the diffusing layer. The overall high light energy is imaged in low loss manner on the small format image recording device. The system has a high light intensity permitting use even under difficult lighting conditions.

The light-diffusing substance is a very fine grain substance which is placed in the gap between the support bodies of the imaging lens arrangement and is advantageously a wax. According to a further development preference is given to a mixture of paraffin and white beeswax, the recorded image when compared with a digital image recording where the image often appears with cold colours not meeting cine requirements, has a warm emission pleasing to the observer and such as is known from cine recordings in the large 35 mm format. This “filmlook” of an analog image with a warm, pleasing emission is obtained with a wax mixture of approximately 2 to 60% beeswax and preferably 5% white beeswax. By varying the mixing ratios the half-power angle of the wax layer can be matched to the layer thickness and focal length of the planoconvex, back projection lens following in the optical path.

Prior to filling the liquid wax into the gap between the plane-parallel surfaces of the support bodies, the gap is fixed to the necessary width. In preferred imaging optics the layer thickness is less than 0.15 mm. A layer thickness of 0.08 mm can be advantageous and use can also be made of layer thicknesses of 2-3/100 mm or less. Such a thin gap can be fixed with rubber threads prior to filling the gap with the liquid wax.

In general, paraffin-containing substances have proved advantageous as materials for the diffusing layer. In conjunction with other substances, paraffin can be processed to a polymer having the desired diffusing properties.

Using the inventive imaging lens arrangement it is possible without the supply of any type of energy and therefore in cost-effective, noiseless manner, it is possible to produce an image with a high contrast and a very good detail solution, the soft-focus effect of the focussing screens according to the prior art being greatly reduced and generally invisible.

For the further collection of the light energy made available by the upstream lens, it is possible to place in the optical path directly behind the imaging lens arrangement a field lens arrangement, so that the adapter length is shortened and the light yield is improved. To make available an upright image to the camera, preferably behind the back projection lens there is a prism arrangement in the optical path, in which the image is rotated by 180° and therefore brought into an upright position. The prism arrangement is advantageously positioned behind the field lens. For erecting the image use can be made of two Porro prisms with a triangular cross-section, the image in each case penetrating through the base of the Porro prism and is totally reflected on both lateral faces. As a result of several total reflections the optical path in the imaging device is lengthened, so that overall the device can be made compact. There is a axially parallel configuration of the optical path and in particular a large format video camera can be positioned at the end of the optical path with limited vertical or lateral displacement and in an axially parallel position with respect to the upstream lens. Preferably a roof or Schmidt or Amici prism is located behind the imaging lens arrangement and in an individual prism block several reflections occur for lengthening the optical path and the image is issued in erected form.

In a preferred development the prism is constructed in such a way that the image issuing or output direction is at an angle to the image incidence, e.g. using a 45° Schmidt prism. The optical device can therefore be fitted with a tubular housing upstream of the camera used, so that there is a compact overall arrangement and the latter can be easily shouldered. The set horizontal camera can be ergonomically carried with the optical device on the shoulder of a cameraman and also the centre of gravity of the system is lower, so that a more stable camera control is possible.

With this imaging lens arrangement and its focal length, combined with a telephoto lens and the field lens arrangement, the following prism and a field lens upstream of the telephoto lens a very short total length can be obtained, because the individual optical components can also be arranged in densely spaced manner in the adapter housing.

Advantageously the imaging lens arrangement is placed in a container of poor heat-conducting material within the adapter housing, so that the imaging lens arrangement is protected against significant heat action in the adapter interior. The container can be a ring of nonmetallic material, preferably plastic, such as e.g. polyamide or polystyrene. The service life of the imaging lens arrangement is greatly increased by the insulation. The imaging lens arrangement is advantageously detachably received in the container and/or the container can be released from the adapter, so that a replacement of a worn out imaging lens arrangement or a removal of the latter for cleaning purposes is made much easier. It is also possible to keep available imaging lens arrangements having different characteristics, such as e.g. different layer thicknesses, mixing ratios of wax mixtures, etc. for replacement purposes and the adapter characteristics can be adapted as a function of the requirements of the given film situation. Moreover, by removing the imaging lens arrangement from the optical path, an aerial image imaging can take place and the image detected by the lens can be transmitted via the field lens, prism and eyepiece to the reproducing equipment, such as a video camera or photographic camera and as a result a very high power image can be obtained. The aerial image is recorded with the same advantageous viewing angle as when combining the optical components with the imaging lens arrangement and it can be advantageous to fit the field lens in movable manner.

According to an advantageous development at least part of the optical device is constructed as an optical adapter for replaceable connection to the camera. It is possible inter alia for the imaging lens arrangement and transmission lens, optionally with interposed field lens and prism arrangements, to be combined into a single module. The module can e.g. be connected by a standardized bayonet joint to the corresponding lens bayonet receptacle of different cameras without any further adaptation work. The optical adapter is appropriately provided for fixing in the vicinity of the transmission lens of the camera. Particularly in the case of small video cameras with fixed-installed, non-replaceable lens, the camera lens can be used as the transmission lens. The optical, auxiliary adapter can be made correspondingly compact without having its own transmission lens and optionally for the transmission optics a field lens is positioned upstream of the transmission lens.

An integrated construction of the imaging device with the camera can also be advantageous, a video chip or a comparable image recording device being integrated into the imaging device. By means of a suitable electronic circuit it is possible to electronically erect the real diffusing layer image and then there is no need for an erecting prism arrangement.

An embodiment of the invention is described hereinafter relative to the attached drawings, wherein show:

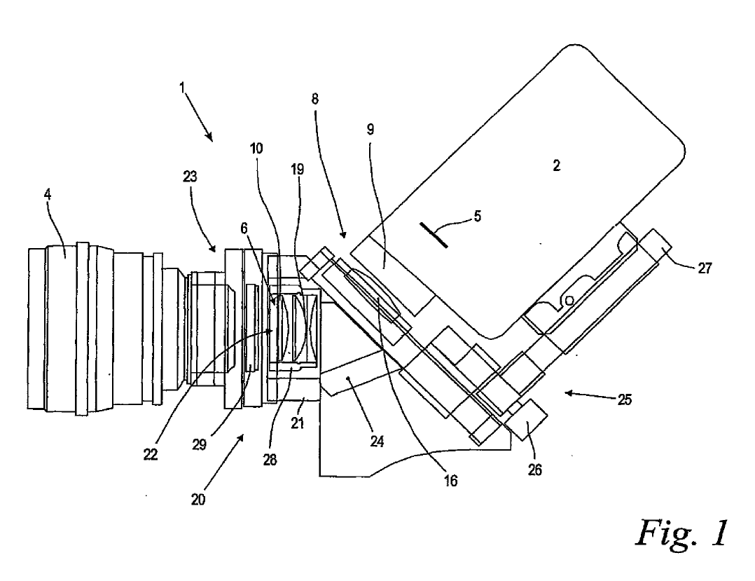

FIG. 1 A diagrammatic view of an optical device connected to a video camera.

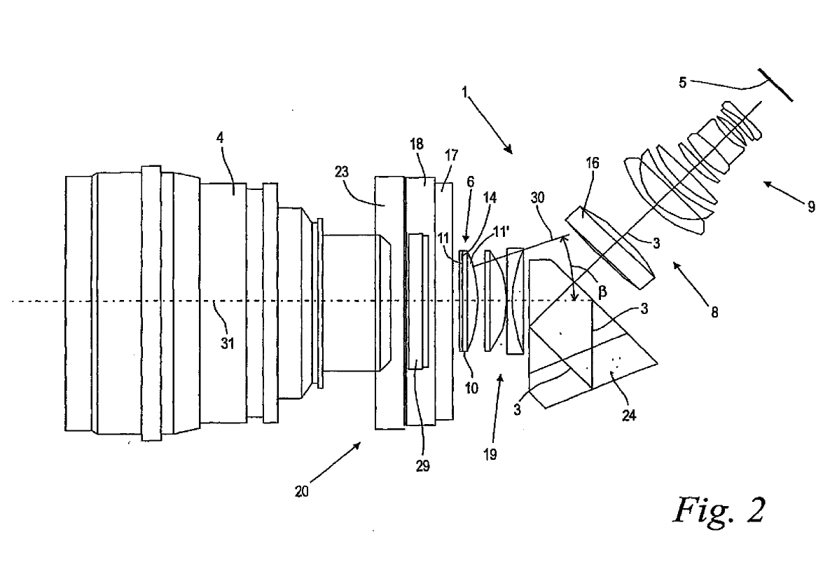

FIG. 2 The optical path in the optical device according to FIG. 1 with details concerning the optical components located therein.

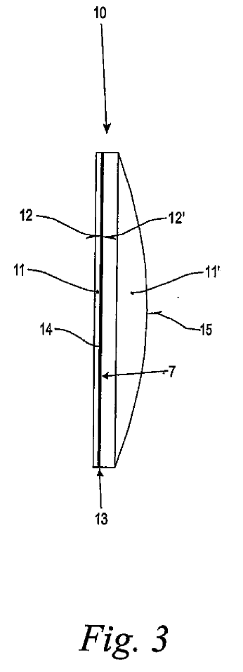

FIG. 3 A larger scale detail view of the imaging lens arrangement of FIGS. 1 and 2.

FIG. 1 shows a small recording format video camera 2, upstream of whose fixed-installed lens 9 is provided an optical adapter 20 in order to obtain the depth of field and therefore a similar image quality to a cine camera operating with large recording formats. Adapter 20 and lens 9 together form an optical device 1. Adapter 20 comprises a tubular body milled from aluminium as housing 21 with a shaft 22 recessed therein for receiving the optically active components. The image passes into the shaft 22 through a large format lens 4 upstream of adapter 20 and encounters an imaging optics 6 constructed as an imaging lens arrangement 10. Lens 4 is replaceably held in a replacement bayonet 23 constructed on the housing 21 of adapter 20 and which is designed as a lens adapter for all standard cine and photographic lenses. The imaging lens arrangement 10 described in greater detail hereinafter relative to FIG. 3 comprises two lens blocks, between which is placed a light-diffusing layer in order to render visible the real image from lens. The light leaving the imaging lens arrangement 10 is focussed with the aid of a field lens arrangement 19 following in the optical path of adapter 20 and is passed through a 45° Schmidt prism 24 in which the image is rendered upright by multiple reflection by 180°.

A transfer or transmission optics 8 are provided comprising the transmission or transfer lens 8 of the camera and a field lens 16 upstream of the latter. By means of the transmission optics 8 the real image of lens 4 imaged on the imaging lens arrangement 10 is transmitted or transferred to an intimated image recording device 5 of camera 2. In the embodiment shown the image recording device 5 is a ⅓ inch format, photosensitive video chip. It is also possible to use other format, such as the ⅔ inch format normally used in larger cameras, or films with correspondingly small photographic or cine formats.

As a result of the angular deviation of the optical path with respect to the incidence direction, camera 2 can be set with respect to adapter 20 and lens 4 in accordance with the angular direction of prism 24, i.e. in the present case 45°, so that the overall arrangement comprising camera 2 with fitted adapter 20 is characterized by a very short construction configuration.

The overall arrangement of adapter 20 and camera 2 is carried on the shoulder of an operator using a shoulder holder, the angular arrangement of the adapter 20 with respect to the camera 2 allowing ergonomic carrying and also a stable control as a result of the low centre of gravity position of the overall arrangement.

Housing 21 of adapter 20 is firmly connected to a fastening device 25 for camera 2. The fastening device 25 comprises several rails 26, 27 arranged in cruciform manner like a coordinate system with respect to one another and in which the camera 2 is displaceably mounted by means of slides. Slide guidance makes it possible to displace the camera 2 in three space axes and an adjustment of the lens 9 of camera 2 with respect to the field lens 16 of adapter 20. The fastening device also ensures a use of adapter 20 on different cameras, which are easily adjustable with the aid of the fastening device 25. The slides can be moved to the intended end position for camera 2 with the aid of a fine pitch drive, whose setscrew cooperates with a thread receptacle. The fine pitch drive has a fast displacement mechanism in order to approximately, but rapidly move up to the intended end position and then finely adjust the camera position using the setscrew. The main slide guides are manufactured from 12 to 16 mm thick carbon or light metal pipes, whilst the rail guides are preferably made from light metal. Following adjustment the camera 2 can be fixed by securing the slides using bent levers.

In this way it is readily possible to connect adapter 20 upstream of any camera 2 with focal lengths in the medium telephoto range, the focal length range of the transmission lens in the form of a zoom lens extending from 20 to 65 mm inclusive. The sharpness of the camera transmission lens 8 is set to infinity, so that without the use of further optical aids such as close-up lenses and the like, sharp imaging occurs of the real image of the imaging lens arrangement 10 on image recording device 5, the adapter can be rapidly connected and photographic recordings with filmlook are possible.

The imaging lens arrangement 10 is received in a container 28 made from a poor heat-conducting plastics material. The container 28 can be a ring, which at least covers the wax layer between the two support bodies or, as in the present embodiment, is made with a greater axial length and also receives therein the field lens arrangement 19. Container 28 with the imaging lens arrangement 10 is releasably received in shaft 22 of tubular housing 21, so that if need be the imaging lens arrangement 10 can be replaced. This leads to a thermal protection for the imaging lens arrangement 10 in housing 21 which is heat sensitive due to its wax content and also the imaging lens arrangement 10 can be replaced for cleaning purposes or for removing damaged lenses. In connection with the replacement of the imaging lens arrangement 10, it is also possible for the operator to carry in a magazine lenses having different characteristics as a result of a differing thickness of the light-diffusing wax layer or wax mixtures.

Between the imaging lens arrangement 10 or container 28 with said arrangement 10 therein and the field lens arrangement 19, upstream of shaft 22 of tubular housing 21 is provided a holder for filters 29 adjacent to lens 4 and which if required can be placed in the optical path.

FIG. 2 diagrammatically shows on a larger scale the optical device 1 of FIG. 1 with details of optical components to be placed therein. Optical device 1 is constructed as an integrated optical adapter 20 on which, at the entry side, the lens 4 is held by means of the replaceable bayonet 23. On the entry side and in the direction of lens 4, the optical adapter 20 comprises the replacement bayonet 23 and on its exit side the integrated transmission lens 8 and the interposed, subsequently described, further optical and mechanical elements.

The imaging optics 6 are constructed as an imaging lens arrangement 10 with two transparent support bodies 11, 11′ with an interposed, light-diffusing layer (diffusing layer) 14. An intimated diffused light beam 30 deflected by the diffusing layer 14 and lens 11′, with respect to an optical axis 31 forms a half-power angle of <approximately 25° and in the embodiment shown this is in the range 20 to 15°. The light beam 30 represents the emission direction in which the light intensity behind the imaging lens arrangement is only half as high as on the optical axis 31.

A field lens arrangement is placed directly behind the imaging lens arrangement 10 in the optical path 3 of optical device 1. The field lens arrangement 19 can comprise one or more field lenses and in the embodiment shown is implemented as a combination of a planoconvex lens with a following planoconcave lens.

Along the optical path 3, which in the vicinity of lens 4 and imaging optics 6 runs parallel to optical axis 31, a prism arrangement in the form of a roof or Schmidt prism 24 is positioned behind imaging lens arrangement 10 and behind the following field lens arrangement 19 and supplies the image of the imaging lens arrangement 10 rotated by 180°.

At the exit side of prism 24 is provided a field lens 16, which is upstream of the transmission lens 9 integrated into optical adapter 20.

By means of the transmission lens 9 the real image imaged by the upstream lens 4 on imaging lens arrangement 10 is transmitted on the intimated image recording device 5 along optical path 3.

The transmission lens 9 is constructed as a zoom lens which, based on the size of the image recording device 5, is constructed as a telephoto lens in the medium telephoto focal length range. The transmission lens 9 is focussed to infinity and assisted by the upstream field lens 16 the real image of the imaging lens arrangement 10 is sharply imaged on the image recording device 5. Optical adapter 20 with the integrated transmission lens 9 can be connected without adaptation to standardized lens bayonet receptacles of different cameras 2 (FIG. 1).

Between the replacement bayonet 23 and imaging lens arrangement 10 is provided a filter support 18 and is fixed to optical device 1 by a further bayonet joint 17. The filter support 18 holds an optical filter 29, which in the embodiment shown is in the form of a contrast filter. It is also possible to provide other filters, such as effect filters, etc. In the vicinity of the bayonet joints 17, 23, the imaging device 1 can be dismantled, which gives free access to the imaging lens arrangement 10 in the case of an overall, compact construction.

With regards to the remaining features and reference numerals, the arrangements of FIGS. 1 and 2 coincide. More particularly in the embodiment according to FIG. 2, a housing 21 not shown so as not to overburden representation, as well as further features of the arrangement of FIG. 1 can be provided.

FIG. 3 in a larger scale, diagrammatic detail representation shows the imaging lens arrangement 10 of FIGS. 1 and 2. The imaging lens arrangement 10 comprises two transparent support bodies 11, 11′ bounding with plane-parallel, horizontal surfaces 12, 12′ a gap 13. Gap 13 is filled with a layer 14 of a light-diffusing substance (diffusing layer) for forming an imaging surface 7. Thus, the imaging surface 7 is in the immediate vicinity of the two planar surfaces 12, 12′ of support bodies 11, 11′. The real image produced by the upstream lens 4 (FIGS. 1 and 2) is visible on imaging surface 7.

The entry-side support body 11 is constructed as a plane-parallel plate and the exit-side support body 11′ as a planoconvex lens with an outwardly curved surface 15, which registers with the diffusing layer 14.

The width of gap 13 and the light-diffusing characteristics of layer 14, as well as lens 11′ are so matched to one another that the half-power angle according to FIG. 2 is obtained.

Gap 13 between support bodies 11, 11′ is less than 0.15 mm wide, whilst the light-diffusing substance of layer 14 is a wax. The wax is constituted by a mixture of paraffin and 2 to 60%, preferably 5% white beeswax.

An arrangement can also be appropriate in which the entry-side support body 11 is constructed as a planoconvex lens and it is possible to combine with a planoconvex or plane-parallel construction of the exit-side support body 11′.

In a further appropriate variant, the light-diffusing imaging surface 7 is e.g. placed on the planar surface 12′ of support body 11 as an independent layer or by matting or frosting surface treatment of planar surface 12′ and there is then no need for the upstream support body 11.

Besides the embodiments of partly integrated optical adapters 20 shown in the drawings, it can also be appropriate to have a completely integrated solution, in which the image recording device 5 (FIGS. 1 and 2) is integrated into the optical device 1, optionally with a complete camera 2.

1. An Optical device for a photographic camera, such as a camera, cine or video camera, which is positioned in the optical path between a lens (4) at the start of the optical path and an image recording device of camera at the end of optical path, comprising:
imaging optics with a transparent light-diffusing imaging surface for rendering visible a real image of lens; and
transmission optics with a transmission lens for imaging the real image of lens on image recording device,
wherein the imaging optics are constituted by an imaging lens arrangement containing a diffusing layer of a light-diffusing substance, together with a lens, which with an outwardly curved surface is in register with the diffusing layer, the imaging lens arrangement having a half-power angle of equal to or small than 30° and larger than 10°.

2. Optical device according to claim 1, in which the half-power angle is smaller than 25°, particularly smaller than 22°.

3. Optical device according to claim 1 wherein the half-power angle is in the range between 20 and 15° inclusive.

4. Optical device according to claim 1, wherein the imaging lens arrangement comprises two transparent support bodies defining with plane-parallel, horizontal surfaces a gap into which is introduced the light-diffusing substance in such a way that the diffusing layer is received between the plane-parallel surfaces.

5. Optical device according to claim 1, wherein at least one of the support bodies is constructed as a lens block, so that the diffusing layer engages directly on a planar surface of the lens block.

6. Optical device according to claim 4, wherein in the case of the imaging lens arrangement an entry-side support body of the two transparent support bodies is constructed as a plane-parallel plate and an exit-side support body is constructed as a planoconvex lens.

7. Optical device according to claim 4, wherein the gap between the support bodies is less than 0.15 mm wide.

8. Optical device according to claim 1, wherein the diffusing layer is a self-supporting layer.

9. Optical device according to claim 1, wherein the light-diffusing substance of the diffusing layer in imaging lens arrangement is a wax.

10. Optical device according to claim 9, wherein the wax is a mixture of paraffin and white beeswax.

11. Optical device according to claim 10, wherein the mixture contains approximately 2 to 60% white beeswax, preferably 5% beeswax.

12. Optical device according to claim 1, wherein the light-diffusing substance of the diffusing layer contains paraffin.

13. Optical device according to claim 1, wherein, based on the size of the image recording device, the transmission lens is constructed as a telephoto lens, particularly in the medium telephoto focal length range.

14. Optical device according to claim 13, wherein the telephoto lens is a zoom lens.

15. Optical device according to claim 1, wherein the optical device is designed in such a way that, in the case of infinite focussing, the transmission lens images sharply on the image recording device the real image of the imaging surface.

16. Optical device according to claim 15, wherein a field lens is positioned upstream of the transmission lens for sharp imaging purposes in the case of infinite focussing.

17. Optical device according to claim 1, wherein a film support replaceable by a bayonet joint or screw joint is placed between lens and imaging lens arrangement.

18. Optical device according to claim 1, wherein a field lens arrangement is placed in the optical path in the optical device directly behind the imaging lens arrangement.

19. Optical device according to claim 1, wherein behind the imaging lens arrangement and in particular behind the field lens arrangement a prism arrangement is provided in optical path and supplies the image of imaging lens arrangement rotated by 180°.

20. Optical device according to claim 19, wherein a roof or Schmidt prism is provided as the prism arrangement.

21. Optical device according to claim 1, wherein at least part of the optical device is constructed as an optical adapter for replaceable connection to the photographic camera.

22. Optical device according to claim 21, wherein the optical adapter is provided for fixing in the vicinity of the transmission lens of the camera.
